(19) United States
(12) Patent Application Publication
(10) Pub. No.: US 2006/0224791 A1
(43) Pub. Date: Oct. 5, 2006

(54) Dual USB port device

(76) Inventor: Karl Edward Keppeler, Bellport, NY (US)

Correspondence Address: FAY KAPLUN & MARCIN, LLP, 15O BROADWAY, SUITE 702, NEW YORK, NY, 10038, US

(21) Appl. No.: 11/095,684

(22) Filed: Mar. 31, 2005

(51) Int. Cl. G06F 13/38

(52) U.S. Cl. 710/62

(57) ABSTRACT

Described is a system which includes a first device connected to a second device via a USB cable. The cable has a first USB connector and a second USB connector. The first device includes a first USB port, a second USB port and a voltage detector coupled to the second port. The detector detects a voltage at the second port. The first port is configured to accept the first connector and the second port is configured to accept the second connector. The second device includes at least one of a third USB port and a fourth USB port. The third port is configured to accept the first connector and the fourth port is configured to accept the second connector. The first device switches operation between a host state and a client state based on the detected voltage at the second port.

### BACKGROUND

A Universal Serial Bus (“USB”) provides a single, standardized, easy-to-use mechanism for connecting computing devices and exchanging data therebetween. A USB connection between, for example, a personal computer (“PC”) and a peripheral device (e.g., PDA, digital camera) is typically accomplished via a USB cable with a four-pin connector on each end. That is, a first end of the cable is an “A” connector and a second end of the cable is a “B” connector. The A connector is plugged into an A port on of a host (e.g., the PC) and the B connector is plugged into a B port of a client (e.g., the peripheral). As well as exchanging data, a low-power peripheral device (e.g., a mouse, a keyboard) may draw power from the PC, while a high-power peripheral device (e.g., a printer) may have its own power supply.

In conventional systems, PCs are typically equipped with A ports and peripheral devices are typically equipped with B ports. Thus, in the USB connection, the PC is usually the host and the peripheral device is usually the client. This prevented the USB connection between two or more peripheral devices, and prevented the peripheral device from ever becoming the host. For example, a PDA could not have established the USB connection to the digital camera. Each device was the client having the B port, and the USB cable has only one A connector and one B connector.

A single USB port (e.g., a mini-AB port) was designed to overcome the problems faced by the conventional systems. The mini-AB port allowed the peripheral device to act as either the host or the client, upon connection of a further device (e.g., PC or peripheral device). The mini-AB port receives a further USB cable which includes two five-pin connectors, a mini-A connector on a first end and a mini-B connector on a second end. In the mini-A connector, an identification (“ID”) pin (e.g., a fifth pin) is grounded, while in the mini-B connector, the ID pin remains floating. Thus, if the mini-AB port receives the mini-A connector, it is the host; and if it receives the mini-B connector, it is the client.

While the mini-AB port overcomes the problem of the conventional systems, the peripheral devices which utilize the “standard” A port and the “standard” B port may become extinct if the mini-AB port becomes the standard on such devices. To utilize the mini-AB port, users of the peripheral devices with the standard A and B ports, must discard such devices and purchase those with the mini-AB port. This may represent significant costs in new hardware purchases, as well as training and maintenance for the new hardware. Thus, there is a need for a peripheral device which has a capability of becoming either the host or the client and which utilizes the standard A and B ports.

### SUMMARY OF THE INVENTION

The present invention relates to a system which includes a first device connected to a second device via a USB cable. The cable has a first USB connector and a second USB connector. The first device includes a first USB port, a second USB port and a voltage detector coupled to the second port. The detector detects a voltage at the second port. The first port is configured to accept the first connector and the second port is configured to accept the second connector. The second device includes at least one of a third USB port and a fourth USB port. The third port is configured to accept the first connector and the fourth port is configured to accept the second connector. The first device switches operation between a host state and a client state based on the detected voltage at the second port.

### BRIEF DESCRIPTION OF THE DRAWINGS

FIG. 1a shows a standard A connector of a USB cable;

FIG. 1b shows a standard B connector of the USB cable;

FIG. 2 shows an exemplary embodiment a dual USB port device according to the present invention;

FIG. 3a shows an exemplary embodiment of the device of FIG. 2 coupled a further device using the USB cable;

FIG. 3b shows another exemplary embodiment of the device of FIG. 2 coupled a further device using the USB cable; and

FIG. 4 shows an exemplary embodiment of a method according to the present invention.

### DETAILED DESCRIPTION

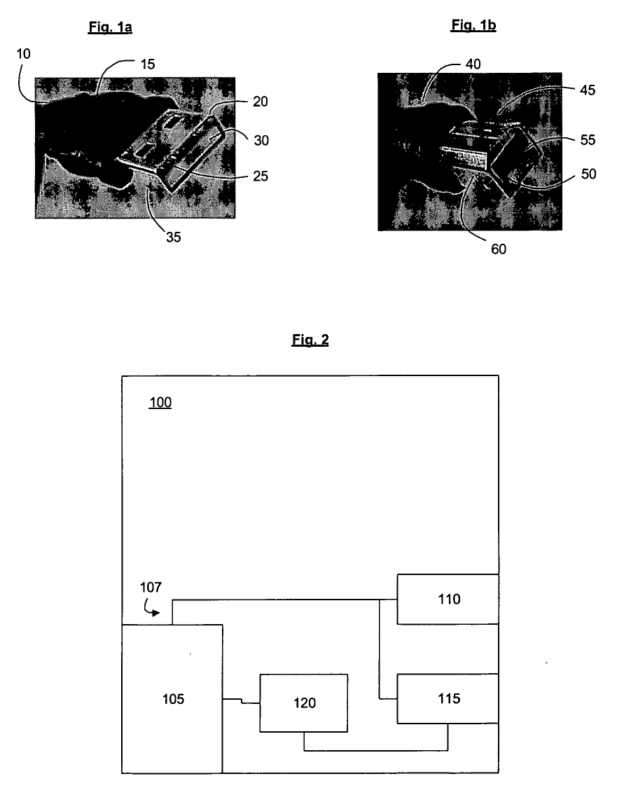

The present invention may be further understood with reference to the following description and the appended drawings, wherein like elements are referred to with the same reference numerals. As shown in FIG. 1a, a USB cable 10 has a first end 15 with an A connector 20 attached thereto. The cable 10 has typically four wires: two wires for power (+5 volts and ground) and a twisted pair of wires to carry data. The cable 10 may be either a high-speed cable providing data communication at twelve megabits per second or a low-speed cable providing data communication at 1.5 megabits per second. Furthermore, the cable 10 may have a first predefined length (e.g., no greater than 5 meters) when it is the high-speed cable, and a second predefined length (e.g., no greater than 3 meters) when it is the low-speed cable. Those of skill in the art would understand that the cable 10 may be coupled to a further cable via a hub (not shown). When connecting the cable 10 to the further cable, the hub may be used essentially as a repeater to increase a total cable length.

As understood by those of skill in the art, the A connector 20 includes four pins 25 disposed on or embedded in a substrate 30 within a flat, rectangular housing 30. Each pin 25 includes a portion thereof which is enclosed by the substrate 30 and a further portion which is exposed to an external environment. Thus, each pin 25 provides a contact for power and for exchange of data when the A connector 20 is inserted into a host (e.g., a PC).

FIG. 1b shows a second end 40 of the cable 10 including a B connector 45 attached thereto. As understood by those of skill in the art, the B connector 45 includes four pins 50 disposed on or embedded in a substrate 55 within a substantially square housing 60. Similar to the A connector 15, each pin 50 includes a portion thereof which is enclosed by the substrate 55 and a further portion which is exposed to an external environment. Thus, each pin 50 provides a contact for power and for exchange of data when the B connector 20 is inserted into a client (e.g., a peripheral device).

Generally, a host (e.g., PC) has an A port for receiving the A connector 15 and a client (e.g., conventional peripheral device (“CPD”)) has a B for receiving the B connector 45. After the connection of each, the PC and the CPD may exchange data, and the CPD, if it is a low-power CPD (e.g., a mouse, a keyboard) may draw power from the PC. In this manner, the PC is a host and the CPD is a client. As understood by those of skill in the art, the host initiates all communications and controls the flow of information between itself and the client. In general, the host is considered to be the intelligent, controlling device, while the client is usually the dumb, slave device. However, as noted above, the cable 10 does not provide for connection of the CPD to a further CPD. That is, the port of the CPD only receives the B connector 45, and the B connector 45 is structurally dissimilar to the A connector 15, as shown in FIGS. 1a and 1b, preventing exchangeability thereof.

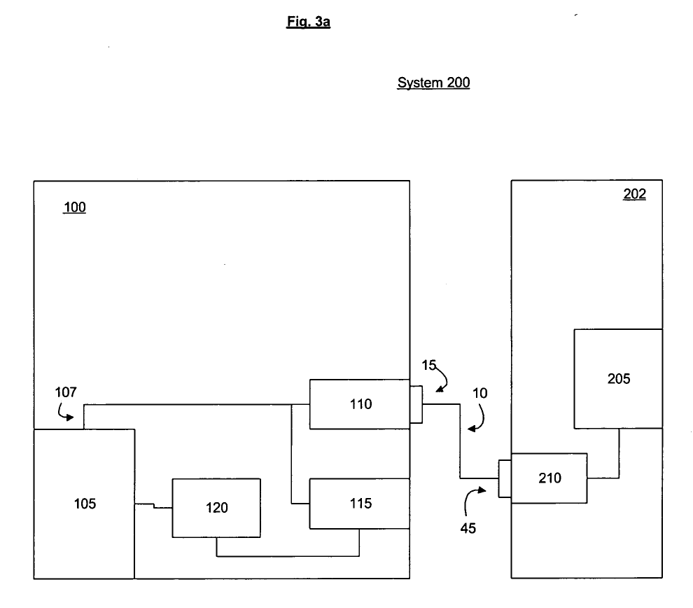

According to the present invention, a computing device 100, shown in FIG. 2, is provided with a capability to act as either the host or the client. The device 100 may be any peripheral device, such as, for example, a personal digital assistant (“PDA”), a scanner, a cell phone, a digital camera or any peripheral device which has the capability of acting as a host in addition to being a client.

The device 100 includes a processor 105 coupled to a first USB port (e.g., a standard A port 110) and a second USB port (e.g., a standard B port 115). In a preferred exemplary embodiment, each port 110, 115 is coupled to the processor 105 via a same processor port 107 as shown in FIG. 2. In another exemplary embodiment, each port 110, 115 is coupled to the processor 105 via two different processor ports (not shown). As understood by those of skill in the art, the A port 110 is configured to receive the A connector 15 on the cable 10, and the B port 115 is configured to receive the B connector 45. That is, the A port 110 may include a receptacle which has a flat, rectangular shape to receive the housing 30 of the A connector 15, and the B port 115 may include a receptacle which is substantially square-shaped to receive the housing 60 of the B connector 45. Each receptacle may be sized such that each connector 15, 45 is frictionally maintained within the corresponding port 110, 115. Alternatively, each connector 15, 45 may be locked or snap-fit within the corresponding port 110, 115.

The device 100 may further include a voltage detector 120 coupled to the processor 105. The voltage detector 120 is also coupled to the B port 115 in order to measure a voltage (e.g., 5 V) received thereby from the B connector 45. That is, if the B connector 45 is inserted into the B port 115, the voltage thereof will detected. The voltage detector 120 detects this increase (i.e., presence/absence of the voltage) and notifies the processor 105. As understood by those of skill in the art, the voltage detector 120 and tasks executed thereby may be implemented in software and/or hardware. That is, in another exemplary embodiment of the device 100, the B port 115 may be directly coupled to the processor 105. Thus, the processor 105 may execute a software application which performs the task of detecting the voltage at the B port 115.

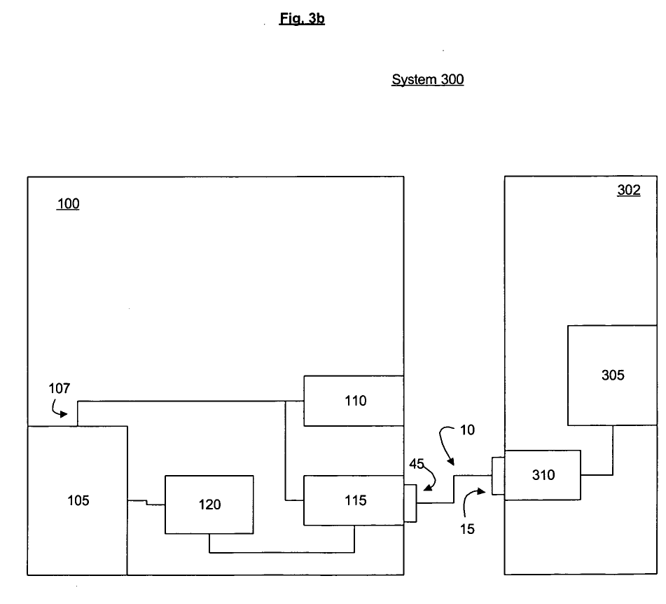

According to the present invention, the device 100 has two states which define its operation in response to insertion of one of the connectors into one of the ports. In a first state (e.g., a host state), the device 100 acts as a host in a USB connection. That is, the A port 110 has received the A connector 15, and the B connector 45 is attached to a further peripheral device (“FPD”) 202 shown in FIG. 3a. In a preferred exemplary embodiment, the device 100 defaults to the host state. In a second state (e.g., a client state), the device 100 acts as a client in the USB connection. That is, the B port 115 has received the B connector 45, and the A connector 15 is attached to a device 302, as shown in FIG. 3b. The voltage detector 120 provides an indication to the processor 105 of which state the device 100 should be in based on whether the voltage was detected at the B port 115.

As shown in FIG. 3a, an exemplary embodiment of a system 200 includes the FPD 202 coupled to the device 100 via the cable 10. In this embodiment, the FPD 202 may be, for example, a digital camera, a keyboard, a mouse, a barcode scanner or any other peripheral device. The FPD 202 includes a processor 205 which is coupled to a further B port 210. The FPD 202 may further include a power arrangement (e.g., a battery) providing power to the processor 205 when the FPD 202 is not coupled to, and draws power from, the device 100. In another exemplary embodiment, the FPD 202 may include a further A port, which will be described below with reference to FIG. 3b.

In FIG. 3a, the B connector 45 of the cable 10 has been inserted into the further B port 210 of the FPD 202, and the A connector 15 has been inserted into the A port 110 of the device 100. Upon insertion of the A connector 15 into the A port 110, the device 100 transmits a voltage to the FPD 202 via the cable 10, because the device 100 is in a default state, which, in this embodiment, is the host state. The device 100 also detects the presence of a voltage at the B port 115 via the voltage detector 120. As understood by those of skill in the art, the voltage detector 120 may continually detect the voltage at the B port 115, or detect the voltage at predetermined intervals or events (e.g., time periods, insertion of one of the connectors 15, 45, etc.). In this embodiment, the voltage at the B port 115 is zero, because the B connector 45 has not been inserted thereinto. Thus, the voltage detector 120 indicates to the processor 105 that the voltage is zero at the B port 115, and, as a result, the processor 105 remains in the host state. In the host state, the device 100 continually transmits the voltage to the FPD 202 via the cable 10. As understood by those of skill in the art, an amount of current transmitted may be adjusted based on a type of FPD 202 (e.g., low-power—mouse, keyboard, etc.).

FIG. 3b shows an exemplary embodiment of a further system 300 which includes the device 100 coupled to a further computing device (“FCD”) 302. In another exemplary embodiment, the device 100 is coupled to an FPD configured similarly to the device 100 or including a mini-AB port. The FCD 302 includes a processor 305 coupled to a further A port 310, and a power arrangement (e.g., a line voltage, a battery) which powers the processor 305 and any device coupled thereto when the device is in the client state. The FCD 302 may act only as the host, and thus, has one or more A ports. In this manner, the A connector 15 has been inserted into the further A port 310 on the FCD 302, and the B connector 45 has been inserted into the B port 115 on the device 100.

Upon insertion of the B connector 45, the B port 115 receives the voltage from the FCD 302. That is, the FCD 302 (or the FPD 202 with the further A port) is in the host state and is transmitting the voltage to the device 100 via the cable 10. However, the device 100 remains in the host state (i.e., default state) until the processor 105 determines that the device 100 should be in the client state. When the B connector 45 is inserted into the B port 115, the voltage detector 120 detects the voltage received from the FCD 302 via the cable 10. Thus, the voltage detector 120 indicates to the processor 105 that the B port 115 is receiving the voltage, and the processor 105, in turn, switches from the host state to the client state. While it has been described that the voltage detector 120 measures the voltage at the B port 115 only, other embodiments of the device 100 may include the voltage detector 120 or a further voltage detector detecting a further voltage at the A port 110. In this manner, once the device 100 switches to the client state, the processor 105 removes the voltage from the A port 110, so it will not try to power another FPD at the same time. Once the B connector 45 is removed from the B port 115, the device 100 may switch back to the host state, or remain in the client state until a subsequent USB connection.

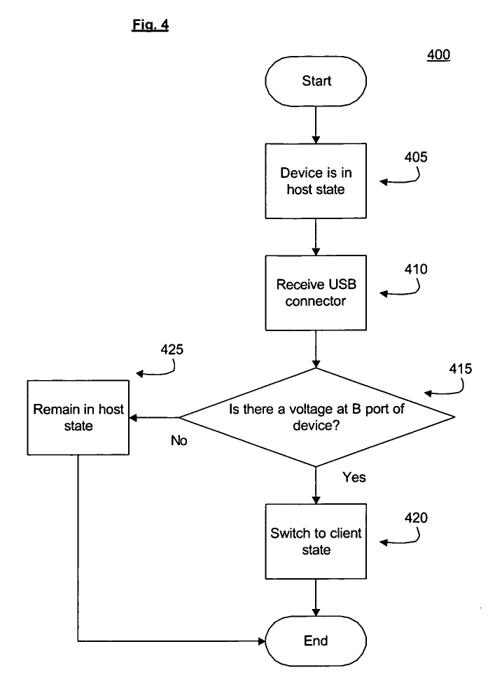

An exemplary embodiment of a method 400 according to the present invention is shown in FIG. 4 and may be implemented in hardware and/or software on the device 100. In step 405, the device 100 is in the host state. As described above, in a preferred embodiment, the default state of the device 100 is the host state. Thus, when the device 100 is not coupled to any other computing devices (e.g., FPD 202, FCD 302), it remains in the host state. In another exemplary embodiment, the default state may be the client state.

In step 410, the device 100 receives the USB connection at either the A port 110 or the B port 115. Preferably, the device 100 only maintains one USB connection at a time. Thus, the device 100 may further include an indicator (e.g., an LED, a door over the non-used port, etc.) which represents that the device 100 is currently maintaining the USB connection. Of course, the ports 110, 115 may be disposed adjacent relative to each other to provide a visual indication that the device 100 is maintaining the USB connection. In another exemplary embodiment, the device 100 may block the port which does not receive the USB connection. For example, if the A port 110 receives the A connector 45, the processor 105 may disable the B port 115 so that if the B connector 45 is inserted therein (while the A connector 45 is still coupled), the B port will be effectively dead (e.g., no power, no data transfer, etc.).

In step 415, the device 100 determines whether there is the voltage at the B port 115. As described above, the voltage detector 120 detects the voltage at the B port 115 and relays such information to the processor 105. Thus, the voltage detector 120 may convert the voltage into a signal to be sent to the processor 105, or it may simply repeat the voltage directly to the processor 105. The processor 105 may be configured to receive the signal and/or the voltage and act based on either.

In step 420, the voltage detector 120 detected the voltage at the B port 115, and the processor 105 switches the device 100 from the host state to the client state. As stated above, the voltage may be detected when the B port receives the B connector 45, and the voltage is passed therethrough from the FCD 302 (or FPD 202) via the cable 10. The voltage detector 120 may continuously detect the voltage at the B port, or may do so at predetermined intervals or events (e.g, time periods, recognition of insertion of the connector 15, 45). Once the voltage detector 120 detects that the voltage is no longer present at the B port 115, a further signal may be sent to the processor 105, at which point the processor 105 may switch back to the host state. Alternatively, the device 100 may remain in the client state until a subsequent USB connection.

In step 425, the voltage was not detected at the B port 115, because, for example, the B port 115 did not receive the B connector 45, a malfunctioned B connector was received, or the device receiving the A connector 15 was not powered (e.g., turned off, dead battery). Thus, the device 100 remains in the host state. As described above, in the host state, the device 100 may transmit the voltage to the FPD 200 via the cable 10.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a processor;
a first USB port coupled to the processor;
a second USB port coupled to the processor; and
a voltage detector coupled to the second port and the processor, the detector detecting a voltage at the second port,
wherein the processor switches operation of the device between a host state and a client state based on the detected voltage.

2. The device according to claim 1, wherein the first and second ports are coupled to a same port of the processor.

3. The device according to claim 1, wherein the first port is configured for a four pin type A connector and the second port is configured for a four pin type B connector.

4. The device according to claim 1, wherein the device is coupled to a further device via a USB cable using one of the first and second ports.

5. The device according to claim 4, wherein when the device is coupled to the further device using the first port, the device is in the host state.

6. The device according to claim 4, wherein when the device is coupled to the further device using the second port, the device is in the client state.

7. The device according to claim 1, wherein the device includes at least one of a computer, a PDA, a cell phone, a mobile computing unit, a portable scanner and a digital camera.

8. The device according to claim 1, wherein a default state of the device is the host state.

9. The device according to claim 1, wherein when the detector detects existence of the voltage, the processor switches the operation of the device into the client mode and when the detector fails to detects the voltage, the processor switches the operation of the device into the host mode.

10. A method, comprising:
detecting a voltage by a voltage detector of a device, the device including at a first USB port and a second USB port, the voltage being detected at the second port; and
switching an operation of the device between a host state and a client state based on the detected voltage.

11. The method according to claim 10, wherein the first and second ports are coupled to a same processor port of device

12. The method according to claim 10, wherein the first port is configured for a four pin type A connector and the second port is configured for a four pin type B connector.

13. The method according to claim 10, wherein the device is coupled to a further device via a USB cable using one of the first and second ports of the device.

14. The method according to claim 10, wherein the device includes at least one of a computer, a PDA, a cell phone, a mobile computing unit, a portable scanner and a digital camera.

15. The method according to claim 10, further comprising the step of:
before the detecting step, switching the device into a default state.

16. The method according to claim 15, wherein the default state is the host state.

17. The method according to claim 10, further comprising:
when the detector detects existence of the voltage at the second port, switching the operation of the device into the client mode.

18. The method according to claim 10, further comprising:
when the detector fails to detects the voltage, switching the operation of the device into the host mode.

19. A system, comprising:
a USB cable having a first USB connector and a second USB connector;
a first device having a first USB port, a second USB port and a voltage detector coupled to the second port, the detector detecting a voltage at the second port, the first port being configured to accept the first connector and the second port being configured to accept the second connector; and
a second device having at least one of a third USB port and a fourth USB port, the third port being configured to accept the first connector and the fourth port being configured to accept the second connector,
wherein the cable connects the first and second devices,
wherein the first device switches operation between a host state and a client state based on the detected voltage at the second port.

20. The system according to claim 19, wherein the first and second ports are coupled to a same processor port of the first device.
